(19) United States
(12) Patent Application Publication
(10) Pub. No.: US 2008/0128628 A1
(43) Pub. Date: Jun. 5, 2008

(54) NEUTRON DETECTORS BASED ON ORGANIC AND INORGANIC POLYMERS, SMALL MOLECULES AND PARTICLES, AND THEIR METHOD OF FABRICATION

(75) Inventors: Daniel Moses, Santa Barbara, CA (US); Thomas Eugene Old, Santa Barbara, CA (US)

Correspondence Address: GATES & COOPER LLP, 6701 CENTER DRIVE WEST, SUITE 1050, LOS ANGELES, CA, 90045, US

(73) Assignee: THE REGENTS OF THE UNIVERSITY OF CALIFORNIA, Oakland, CA (US)

(21) Appl. No.: 11/925,533

(22) Filed: Oct. 26, 2007

Related U.S. Application Data
(60) Provisional application No. 60/863,081, filed on Oct. 26, 2006.

(51) Int. Cl. G01T 3/08

(52) U.S. Cl. 250/370.05

(57) ABSTRACT

A neutron detector, and method for fabricating same, having an active layer comprised of organic and inorganic materials such as polymers and/or small molecules. These materials function as a semiconductor host matrix that transports carriers excited by neutron absorption. The active layer is comprised of host semiconductor materials, composites of the host semiconductor materials with other polymers molecules, and particles, or multi-layer structures of the host semiconductor materials with other materials. The host semiconductor materials include in their molecular structure neutron capturing atoms such as ¹⁰B, ⁶Li, ¹⁵⁷Gd, ²³⁵U, ²³⁹Pu, ⁵¹V, and ¹⁰³Rh, or alternatively are blended with molecules or particles that contain the above atoms in addition to electron accepting molecules or particles. Using these materials allows for the simplified fabrication of inexpensive, large area, relatively lightweight, and flexible neutron detectors via film casting from solution, thermal evaporation, inkjet printing, and film laminate, or film extrusion.

### CROSS-REFERENCE TO RELATED APPLICATIONS

This application claims the benefit under 35 U.S.C. Section 119(e) of the following co-pending and commonly-assigned U.S. patent applications:

U.S. Provisional Application Ser. No. 60/863,081, filed on Oct. 26, 2006, by Daniel Moses and Thomas E. Old, entitled “NEUTRON DETECTORS BASED ON ORGANIC AND INORGANIC POLYMERS, SMALL MOLECULES AND PARTICLES, AND THEIR METHOD OF FABRICATION,” attorneys' docket number 30794.198-US-P1 (2006-728-1);

which application is incorporated by reference herein.

### BACKGROUND OF THE INVENTION

1. Field of the Invention

The present invention relates to the detection of neutrons, particularly thermal or epithermal energies, in the presence of gamma rays in a solid state film comprised of organic and inorganic polymers, small molecules and particles containing neutron-capturing atoms.

2. Description of the Related Art

Researchers have sought more effective neutron detection for use in, for example, homeland security, such as the detection of emitted neutrons by Special Nuclear Materials (SNM), for example, uranium and plutonium. However, effective detection of neutrons is a challenge, because neutron detection typically suffers from problems arising from background noise, high or low detection rates, the neutrality of neutrons and low neutron energies.

Consequently, there is a need in the art for more effective neutron detectors. The present invention satisfies that need.

For example, U.S. Pat. No. 7,186,987, issued Mar. 6, 2007, to Doty et al., discloses a plastic neutron detector made of conjugated polymer contacted with two electrodes. However, because the detector's active layer does not contain atoms (such as ¹⁰B) that capture epithermal or thermal neutrons, the detector may be suitable only for high energy neutron detection, as it relies on the interaction of fast neutrons with the hydrogen of the polymer. In contrast, the present invention discloses a detector with capabilities that are aimed at thermal or epithermal neutrons.

In another example, U.S. Patent Application Publication No. 2004/0227095 A1, published Nov. 18, 2004, by Gerstenmayer et al., discloses a neutron detector having an active layer that comprises a conjugated polymer host and guest semiconductor particles such as CdTe, ZnS, ZnSe or ZnTe, wherein the guest particles preferably have a mean atomic number higher than 14, an average density higher than 2 gm/cm³ and an average relative permittivity higher than 10. Such semiconductor particles do not act as neutron capturing particles nor as electron acceptors, in contrast with the functionality of the particles used in the present invention. Indeed, the particles used in the present invention facilitate either thermal or epithermal neutron capture, or act as electron acceptors. Thus, it seems that the detector described in Gerstenmayer may work for detecting X-rays or Gamma rays, rather than for thermal or epithermal neutrons.

### SUMMARY OF THE INVENTION

The present invention discloses methods for fabricating a neutron detector having an active layer comprised of organic and inorganic materials such as polymers, small molecules and particles. These materials function as a semiconductor host matrix that transports carriers excited by neutron absorption. The active layer is comprised of host semiconductor materials, composites of the host semiconductor materials with other materials, or multi-layer structures of the host semiconductor materials with other materials. The host semiconductor materials include molecules or particles that contain neutron capturing atoms such as ¹⁰B, ⁶Li, ¹⁵⁷Gd, ²³⁵U, ²³⁹Pu, ⁵¹V, and ¹⁰³Rh, in addition to electron accepting molecules or particles. Using these materials allows for the simplified fabrication of inexpensive, large area, relatively lightweight, and flexible, via film casting from solution, thermal evaporation, inkjet printing, film lamination, or film extrusion.

### BRIEF DESCRIPTION OF THE DRAWINGS

Referring now to the drawings in which like reference numbers represent corresponding parts throughout:

FIG. 1 is a schematic block diagram of the neutron detector according to the preferred embodiment of the present invention.

FIGS. 2A and 2B illustrate the molecular structure of poly(3-hexyl thiophene) (P3HT) in FIG. 2A and [6,6]-phenyl-C₆₁ butyric acid methyl ester (PCBM) in FIG. 2B.

FIG. 3 is a graph that depicts the transient photo-current measured in a polymer/fullerene composite layer.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

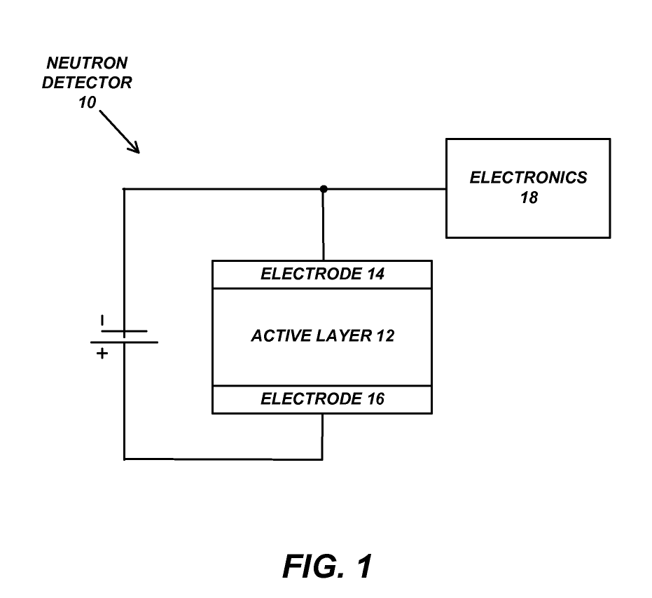

FIG. 1 is a schematic diagram of a neutron detector 10 according to the preferred embodiment of the present invention. The neutron detector 10 includes an active layer 12, sandwiched between two electrodes or contacts 14, 16, and is connected to detection electronics 18. The active layer 12 can be comprised of organic and inorganic materials, such as polymers, small molecules and particles. These materials function as the host semiconductor matrix that transports charge carriers when excited by neutron absorption. Various configurations of the active layer 12 may include these host semiconductor materials, composites of these host semiconductor materials with other materials, or multi-layer structures of these host semiconductor materials with other materials.

The host semiconductor materials or composites typically contain one or more types of neutron capturing atoms, such as ¹⁰B, ⁶Li, ¹⁵⁷Gd, ²³⁵U, ²³⁹Pu, ⁵¹V, and ¹⁰³Rh, as well as electron acceptor molecules. When the neutron capturing atoms capture a thermal neutron, an exothermic reaction occurs that typically results in the generation of charge particles with high kinetic energy. As these particles thermalize, charge carriers are excited in the host semiconductor materials. These high-energy charge carriers can then provide a detection signal for neutron interaction that can be read out electronically.

The most common reaction for the conversion of slow neutrons into directly detectable particles is the ¹⁰B(n,α)⁷₃ Li reaction, upon which reaction products of ⁷Li and ⁴α particles are generated:

₀¹n+₅¹⁰B→₂⁴α+₃⁷Li (1)

The energy liberated in the reaction following neutron capture is very large (2.31 MeV or 2,792 MeV), and this energy is imparted onto the reaction products (⁷Li and α particles). The ⁷Li and α particles thermalize in the host semiconductor materials, thereby exciting charge carriers in the host semiconductor materials, which can be detected by an electrical current or signal generated in the biased active layer 12 of the neutron detector 10.

Using these materials, and their resulting relatively thin layers, allows for the fabrication of relatively inexpensive, large area, lightweight, and flexible neutron detectors 10 via film casting from solution, thermal evaporation, inkjet printing, film lamination, or film extrusion. As a result, the neutron detectors 10 are inexpensive, which means that they can easily be fabricated in large areas and arranged in large arrays. Moreover, such arrays can be fabricated with a large active absorption area. In addition, these large area systems can have any number of different shapes, such as cylindrical, hemispherical, rectangular, etc.

### ALTERNATIVE EMBODIMENTS

One embodiment of the present invention incorporates sub-micrometer particles of ¹⁰BN or semiconducting ¹⁰BN nanotubes into a polymer matrix. For this purpose, it is required to “functionalize” the particles using short organic oligomers capped with a group that adheres to the ¹⁰BN particles; this functionalization facilitates the “solubility” of the inorganic ¹⁰BN particles in organic solvents. It is noted that ¹⁰BN nanotubes are semiconductors, and thus carrier excitation as well as carrier transport can take place in such tubes as well.

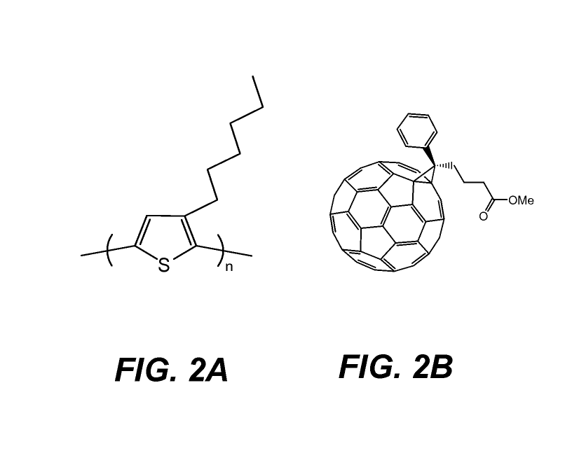

The relative short carrier life-time in a typical polymer semiconductor, extending only a few nanoseconds, can be prolonged significantly by incorporating electron acceptors such as fullerene molecules, their soluble derivatives in the polymer semiconductor, as well as particles such as quantum dots and quantum rods (e.g. made of CdSe, and other inorganic particles), which are known to act as electron acceptors in conjugated polymers (see, e.g., reference 9 below). It is well known that promptly following light absorption in the semiconducting polymer (e.g., a derivative of poly(phenylenevinylene), PPV), for example, within ˜50 femtoseconds (fs), a charge-transfer reaction occurs in which the photo-excited electrons are captured at the fullerene (acceptor) sites, leaving mobile holes on the polymer donor. In typical polymer-based photo-voltaic devices, the active layer film consists of a conjugated polymer:fullerene composite comprised of bicontinuous interpenetrated networks that channel positive and negative photo-induced charges toward their respective electrodes, wherein the conjugated polymer donor network conducts the holes and the fullerene acceptor network conducts the electrons. The charge transfer reaction typically extends the carrier life (i.e., the life time of electrons at the fullerene sites and holes on the polymer chains) by about three orders of magnitude (τ>μs) and thereby facilitates greater carrier collection efficiency. The best known acceptor for many polymer semiconductors is C₆₀, or its soluble derivative [6,6]-phenyl-C₆₁ butyric acid methyl ester (PCBM), which is shown with poly(3-hexyl thiophene) (P3HT), in FIGS. 2A and 2B, respectively. Other organic electron acceptor molecules can be used as well.

An alternative embodiment for incorporating ¹⁰B atoms in the polymer:fullerene composite is via blending with polymers that contain ¹⁰B atoms either in the polymer chain backbone or the polymer chain side groups, such as Borazine-based polymers (i.e., Boron Nitride (BN) polymers). Modified conjugated polymers (e.g., polythiophene or poly(phenylene vinylene)) with side groups that contain neutron capturing atoms (e.g., ¹⁰B) can be used as well. Also, other organic molecules that contain ¹⁰B atoms can be blended with the polymer:fullerene system. Finally, the conjugated polymer can be replaced by small organic molecules that function as the host semiconductor (e.g., Tris(8-Hydroxy)quinoline) Aluminum (Alq₃)). These molecules either contain in their molecular structure neutron capturing atoms such as ¹⁰B or are blended with other molecules that contain such atoms.

Thus, the neutron detector active layer may be comprised of conjugated polymers, materials containing neutron absorbing atoms listed above, and electron acceptor species blended into a composite that is sandwiched by two electrodes (similar to a polymer photo-voltaic device configuration), or configured in multi-layer structure where each layer can comprise one or more of the above materials. Both of these configurations can also include electron and hole injection and transporting layers.

It is well known that the thermal or epithermal energies in the presence of gamma (γ) rays represent neutrons. The low atomic weight of the majority of atoms that comprise organic molecules (hydrogen, carbon, etc.) ensures a relatively small absorption cross-section for γ rays, resulting in the neutron detector having a lower sensitivity to γ radiation, thus providing a good ability for differentiating a signal due to neutrons from a signal due to γ rays.

Moreover, as noted above, the neutron detector active layer can be sandwiched by two thin conducting electrodes and be biased to a moderate-to-high external field. In addition, a detector array can extend significantly the area covered by the neutron detectors.

Experimental Results

As noted above, the present invention has focused so far on a particular composite comprised of a region of regular poly(3-hexyl thiophene), P3HT, and a soluble derivative of C₆₀, [6,6]-phenyl-C₆₁ butyric acid methyl ester, PCBM, which is a fullerene derivative. P3HT was chosen since it exhibits relative high carrier mobility and relatively small gap-energy (˜2 eV). PCBM was chosen since its solubility in organic solvents is better than that of C₆₀. As noted above, FIGS. 2A and 2B illustrate the molecular structure of P3HT and PCBM, respectively.

Similar host composite systems (for the guest species that contain ¹⁰B atoms) may be utilized as the active layer of a neutron detector. Upon absorption of a thermalized neutron by the ¹⁰B atoms, the secondary high energy particles (e.g., α and ⁷Li particles) excite electrons and holes while the α and ⁷Li particles thermalize in the host semiconductor that are collected at the electrodes and thus generate the electrical signal. If electron acceptors (e.g., C₆₀) is chosen to be used in the device, the excited electrons undergo ultrafast charge-transfer reaction to the neighboring C₆₀ acceptor molecules. Thus, every neutron absorbed will generate long-lived electrons at the fullerene continuous network and holes at the polymer network. At sufficient concentration of the C₆₀ in the blend, the probability of electron transfer approaches unity.

It has been demonstrated experimentally that, in such systems, the charge separation via electron transfer from the polymer to the fullerene is indeed quite efficient; however, due to the relatively low carrier mobility in both the conjugated polymer and the fullerene networks, the performance of the neutron detector depends on efficient carrier collection at the metal-organic interfaces. A processing step of thermal annealing improves the device performance due to the enhanced structural order and the resulting enhanced carrier motilities.

Generally, the parameter that determines a carrier collection efficiency is given by the carrier drift length L_{d} given by L_{d}=μιE, where E is the bias field, μ is the charge carrier mobility, and τ is the carrier lifetime. The greater L_{d} with respect to the active layer thickness (W), the greater is the carrier collection efficiency. Increasing the ratio of L_{d}/W can be achieved in two ways: (1) by increasing the carriers' mobility; and (2) by engineering a metallic electrode surface structure that minimize the average distance between an excited carrier in the organic semiconductor and the corresponding metallic electrode so that it is smaller than L_{d}.

In research performed by the inventors, the laser facilities at the University of California, Santa Barbara, an assignee of the present invention, have been utilized extensively. Since the carrier photo-excitation quantum efficiency in semiconductor polymers in the visible and near ultraviolet (UV) regions is known, and because the energy per pulse (and thus the number of photons per pulse) can be measured accurately, pulsed optical excitation is a convenient and effective approach to investigating the transport properties of polymer-based systems. In particular, by either integrating the transient photo-current waveform with respect to time, or by measuring directly the photo-excited charge via a charge sensor, the precise quantum yield (i.e., the ratio of charge-collected/charge-generated) can be deduced for various photo-conductive systems. This facility has been used extensively to characterize the transport properties in various systems being developed.

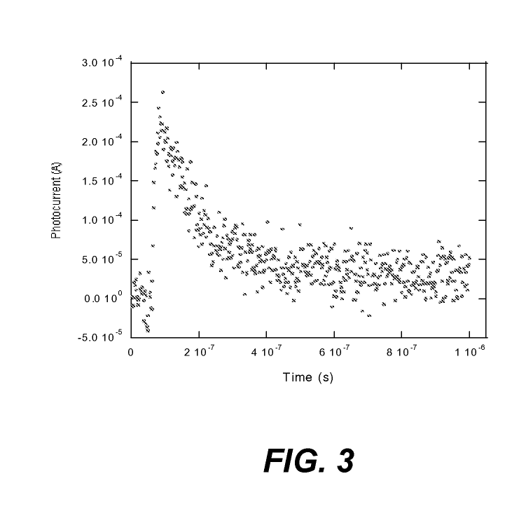

Thus, important information has been obtained from transient photo-conductivity measurements on thin films of such polymer:fullerene composites “sandwiched” between a thin Indium-Tin-Oxide (ITO) transparent conductive layer (that serves as an electrode and as window for the light excitation) and a thin gold top electrode. FIG. 3 is a graph that depicts the transient photo-conductivity measured in a polymer/fullerene composite layer.

The data in FIG. 3 exhibit a photo-current rise (with a rate limited by the capacitance of the device) and then a decay that is followed by almost constant photo-current, up to the maximum time used in these measurements, of 1 μs. These data were obtained for a bias of 2 V (which considering the layer thickness of 100 nm, corresponds to an external field of 2 10⁵ V/cm), and laser pulses of 3.4 10⁹ photons/pulse. Integrating the area of the photo-current waveform up to the maximum time used in the measurement (1 μs), it is estimated that the number of charges (positive and negative) collected during this time is ˜3 10⁸. Thus, the deduced charge quantum yield of this active layer is 0.11 (11%). Assuming that one absorbed neutron generates a number of carriers on the order of 106 charges, and using this yield of 0.11, it is estimated that the number of collected charges would be on the order of 10⁵, which is few orders of magnitude greater than the detection threshold in a sensitive charge sensor.

### REFERENCES

The following references are incorporated by reference herein.
1. G. E. Knoll, Radiation detection and measurement, Third edition (Wiley, New York, 2000).
2. C. Zhi, Y. Bando, C. Tang, S. Honda, K. Sato, H. Kuwahara, D. Goldberg, Agnew Chem 44, 7932 (2005).
3. R. T. Paine and L. G. Sneddon, CHEMTECH 24, 29 (1994).
4. C. H. Lee, G. Yu, D. Moses, N. S. Sariciftci, F. Wudl, and A. J. Heeger, Mol. Crys. Liq. Cryst. 256, 745 (1994).
5. D. Moses, A. Dogariu, A. J. Heeger, Phys. Rev B 61(14), 9373-9 (2000).
6. W. Ma, C. Yang, X. Gong, K. Lee, A. J. Heeger, Adv. Funct. Mater. 15, 1617 (2005).
7. Polymer-based light emitting diodes (PLEDs) and displays fabricated from arrays of PLEDs, X. Gong, D. Moses, A. J. Heeger, in Organic Light Emitting Devices: Synthesis, Properties and Applications, edited by K. Mullen and U. Scherf (Wiley-VCH Verlag GmbH & Co., Weiheim, 2006).
8. M. Cote, P. D. Haynes, C. Molteni, J. Phys.: Condens. Matter 14, 9997 (2002).
9. Wendy U. Huynh, Janke J. Dittmer, A. Paul Alivisatos, Science 295, 2425 (2002).

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A neutron detector having an active layer comprised of organic and inorganic materials that function as host semiconductor materials, wherein the host semiconductor materials contain neutron capturing atoms in addition to electron acceptors, such that the host semiconductor materials transport charge carriers excited by neutron absorption that provide a detection signal for the neutrons.

2. The neutron detector of claim 1, wherein the active layer is comprised of composites of the host semiconductor materials with other materials.

3. The neutron detector of claim 1, wherein the active layer is comprised of multi-layer structures of the host semiconductor materials with other materials.

4. The method of claim 1, wherein the host semiconductor materials comprise conjugated polymers, non-conjugated polymers, oligomers, small molecules or small particles.

5. The method of claim 1, wherein the neutron capturing atoms comprise ¹⁰B, ⁶Li, ¹⁵⁷Gd, ²³⁵U, ²³⁹Pu, ⁵V, or ¹⁰³Rh.

6. The method of claim 1, wherein the electron acceptors comprise organic and inorganic molecules with an affinity for electrons, such as fullerene or soluble derivatives of fullerene.

7. The neutron detector of claim 1, wherein the active layer is sandwiched between two electrodes.

8. A method of fabricating the neutron detector of claim 1 by film casting from solution, inkjet printing, thermal evaporation, film lamination, or film extrusion.

9. A method of detecting neutrons, comprising:
using a neutron detector having an active layer comprised of organic and inorganic materials that function as a host semiconductor material, wherein the host semiconductor materials contain neutron capturing atoms in addition to electron acceptors, such that the host semiconductor material transports charge carriers excited by neutron absorption that provide a detection signal for the neutrons.
